(19) United States
(12) Patent Application Publication
(10) Pub. No.: US 2021/0296026 A1
(43) Pub. Date: Sep. 23, 2021

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: A-NAN YANG, Huaian (CN); HAN-RUN XIE, Huaian (CN); LU-YU CHANG, New Taipei (TW)

(21) Appl. No.: 17/200,872

(22) Filed: Mar. 14, 2021

(30) Foreign Application Priority Data
Mar. 17, 2020 (CN) 202020331305.1

(51) Int. Cl. H01B 11/10; H01B 11/00

(52) U.S. Cl. CPC H01B 11/1091; H01B 11/002

(57) ABSTRACT

A cable includes: a pair of core wires; a first shielding layer covering the pair of core wires; a second shielding layer covering the first shielding layer, and an outer insulating layer covering the second shielding layer; wherein the first shielding layer is a pure metal tape, and the cable is not provided with a separate ground wire.

### BACKGROUND OF THE INVENTION

### 1. Field of the Invention

The present invention relates generally to a cable, and more particularly to a cable used to transmit high frequency signals.

### 2. Description of Related Arts

With the development and popularization of electronic technology products, signal cables are widely used in household appliances, instrumentation, automation equipment, data centers, servers, switches, cloud computing and 5G as a tool for signal transmission. However, in the signal transmission process, the cable is very susceptible to interference from external electromagnetic signals, so it is often necessary to use a shielding structure to eliminate or reduce the interference of the external electromagnetic field, and to prevent the leakage of the transmission signal.

Therefore, it is necessary to provide an improved cable with strong anti-interference performance and stable and reliable signal transmission.

### SUMMARY OF THE INVENTION

A main object of the present invention is to provide a cable which has good shielding effect and stable signal transmission capability.

To achieve the above-mentioned object, a cable comprises: a pair of core wires; a first shielding layer covering the pair of core wires; a second shielding layer covering the first shielding layer, and an outer insulating layer covering the second shielding layer; wherein the first shielding layer is a pure metal tape, and the cable is not provided with a separate ground wire.

Compared to the prior art, the present invention has the advantage that the pure metal as shielding layer improves the shielding effect of high-speed signal cables and ensures the reliability of signal transmission, and the cable of the present invention has the ability to transmit high-speed data signals with a frequency greater than 40 GHz.

### BRIEF DESCRIPTION OF THE DRAWING

FIG. 1 is a cross-sectional view of the cable of the present invention.

### DETAILED DESCRIPTION OF THE PREFERRED EMBODIMENT

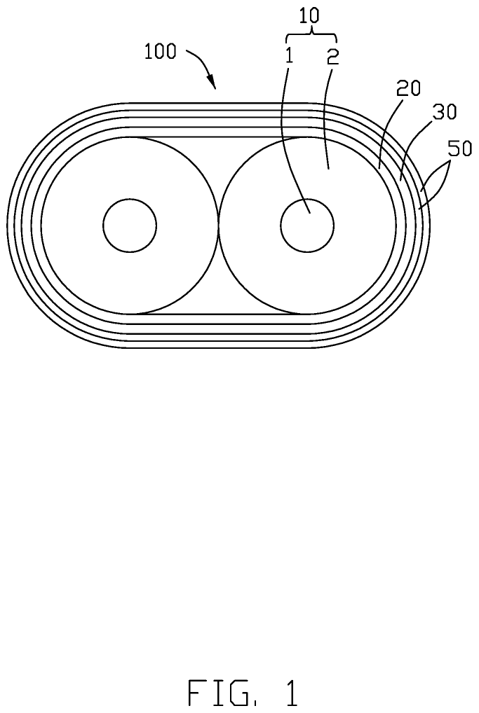

Referring to FIG. 1, which is the cable 100 of the present invention. The cable 100 includes two core wires 10, a first shielding layer 20, a second shielding layer 30 and an outer insulating layer 50 in order from the inside to the outside. The first shielding layer 20 covers the two core wires 10, the second shielding layer 30 covers the first shielding layer 20, and the outer insulating layer 50 covers the second shielding layer 30.

The two core wires 10 are contact with each other and extend in the longitudinal direction. Each of the core wire 10 includes an inner conductor 1 and an insulating layer 2 covering the inner conductor 1. The inner conductor 1 is used for transmitting high-speed signal. The insulating layer 2 of each core wire 10 is extruded and molded to cover the inner conductor 1. The first shielding layer is a pure metal tape. The first shielding layer 20 covers the pair of core wires 10 in a longitudinal wrapping manner. The horizontal wrapping method will have seams between adjacent windings so the longitudinal wrapping has a better shielding effect. The first shielding layer can be used as a ground wire, so that the cable 100 of the present invention does not need to be provided with a separate ground wire, thereby making the cable structure simple and convenient for welding and assembly. In addition, the pure metal tape is used as the shielding layer, which makes the cable shielding effect better. The second shielding layer 30 is a metal foil tape. The metal foil tape includes a PET (polyethylene terephthalate) layer and a metal layer on the PET layer. The metal foil tape uses PET as the base layer, and then spray or calendered a metal layer on the PET layer. The second shielding layer 30 is selected from the aluminum foil (AL/PET) tape and the copper foil (Cu/PET) tape. The second shielding layer 30 is covers the first shielding layer 20 in a longitudinal wrapping manner. The second shielding layer 30 has a certain degree of ductility and is not easy to break, and the second shielding layer 30 also increases the thickness of the entire shielding layer, which increases the shielding effect. The outer insulating layer 50 is made of PET. The outer insulating layer 50 covers the second shielding layer 30 in a spiral winding manner. The outer insulating layer 50 includes two layers, and the two layers are spirally wound in different directions, which can offset the stress from each other, thereby making the structure of the cable more stable.

The cable of the present invention uses pure metal tape as the shielding layer, which improves the shielding effect. At the same time, the cable of the present invention has a high-speed data transmission capability with a signal frequency greater than 40 GHz, provides more options for improving the high frequency characteristics, and is adapted to the current high-speed development.

The above is only some of the embodiments of the present invention, but not all of the embodiments. Any equivalent changes to the technical solutions of the present invention by those skilled in the art by reading the description of the present invention are covered by the claims of the present invention.

What is claimed is:

1. A cable comprising:
a pair of core wires;
a first shielding layer covering the pair of core wires;
a second shielding layer covering the first shielding layer, and
an outer insulating layer covering the second shielding layer; wherein
the first shielding layer is a pure metal tape, and the cable is not provided with a separate ground wire.

2. The cable as claimed in claim 1, wherein the first shielding layer covers the pair of core wires in a longitudinally wrapped manner.

3. The cable as claimed in claim 2, wherein the second shielding layer is a metal foil tape.

4. The cable as claimed in claim 3, wherein the metal foil tape includes a PET layer and a metal layer calendered on the PET layer.

5. The cable as claimed in claim 4, wherein the metal foil tape is made from an aluminum foil tape or a copper foil tape.

6. The cable as claimed in claim 1, wherein the second shielding layer covers the first shielding layer in a longitudinally wrapped manner.

7. The cable as claimed in claim 1, wherein each of the core wires includes an inner conductor and an insulating layer covering the inner conductor.

8. The cable as claimed in claim 1, wherein the outer insulating layer covers the second shielding layer in a spiral winding manner.

9. The cable as claimed in claim 8, wherein the outer insulating layer includes two layers spiral wound in different directions.

10. The method as claimed in claim 1, wherein the outer insulating layer is made of PET.
